(19) United States
(12) Patent Application Publication
(10) Pub. No.: US 2023/0289409 A1
(43) Pub. Date: Sep. 14, 2023

(54) MONETIZATION AND DATA RIGHTS ENABLEMENT IN A DATA MANAGEMENT ECOSYSTEM

(71) Applicant: Dell Products L.P., Round Rock, TX (US)

(72) Inventors: Nicole Reineke, Northborough, MA (US); Stephen J. Todd, North Andover, MA (US)

(21) Appl. No.: 17/654,634

(22) Filed: Mar. 14, 2022

(51) Int. Cl. G06F 21/10; G06Q 30/02

(52) U.S. Cl. CPC G06F 21/10; G06Q 30/0206

(57) ABSTRACT

Exercising user data rights is disclosed. A rights architecture is provided that can be integrated with a data management system. When data is ingested, the associated data rights are also ingested or applied by default. When data is requested, the request is intercepted, the request is intercepted or processed to determine applicable data rights, which are then enforced as the request is handled in the data management system. The data rights may accompany the data in a header when sold or transferred such that the data rights accompany the data and can be enforced.

### FIELD OF THE INVENTION

Embodiments of the present invention generally relate to data rights. More particularly, at least some embodiments of the invention relate to systems, hardware, software, computer-readable media, and methods for enabling, enforcing, and/or monetizing users’ data rights.

### BACKGROUND

In order to use or access websites (or other sources/services) over the Internet, it is often necessary for websites to collect and use personal data. Once a user’s data has been collected, the user often has little control over how that data is used. This has resulted in attempts to protect a user’s data. The California Consumer Privacy Act (CCPA) and the General Data Protection Regulation (GDPA) in Europe are examples of regulations that relate to protecting user’s data.

Even with these laws and regulations, consumers are still faced with the problem that there is no common protocol available for users to express their rights in a standard way. As a result, users are essentially forced to interact with companies one by one. Each of the companies likely has a different way to “opt in” or “opt out” or execute a “right to delete”. Many do not offer users any of these options. Consequently, using all of these entity specific methods is time-consuming and dissatisfying.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a request related to a user’s data rights;

FIG. 2 discloses aspects of data rights in a computing system;

FIG. 3 discloses aspects of setting data rights in a computing system;

FIG. 4 discloses additional aspects of setting data rights;

FIG. 5 discloses aspects of using, enforcing, and/or monetizing data rights; and

FIG. 6 discloses aspects of a computing device or a computing system.

### DETAILED DESCRIPTION OF SOME EXAMPLE EMBODIMENTS

Embodiments of the present invention generally relate to data rights. More particularly, at least some embodiments of the invention relate to systems, hardware, software, computer-readable media, and methods for monetizing and enabling data rights.

Examples of operations related to data rights or to a user’s rights regarding their data include, by way of example, enabling data rights, enforcing data rights, monetizing data rights, setting data rights, deleting data rights, modifying data rights, or the like or combination thereof.

Embodiments of the invention include a data rights system or architecture. The data rights architecture includes a rights engine that allows a user to interact with entities such that the user’s data rights, by way of example, can be set, stored, enforced and/or monetized. The data rights architecture allows an entity to enforce the user’s data rights in the context of the entity’s data management systems and architectures. In one example, the data rights architecture may be integrated with the entity’s data management systems and architectures. When the data rights architecture is implemented, users can assert their rights. In one example, the data rights architecture prevents or helps protect users’ data from unauthorized use.

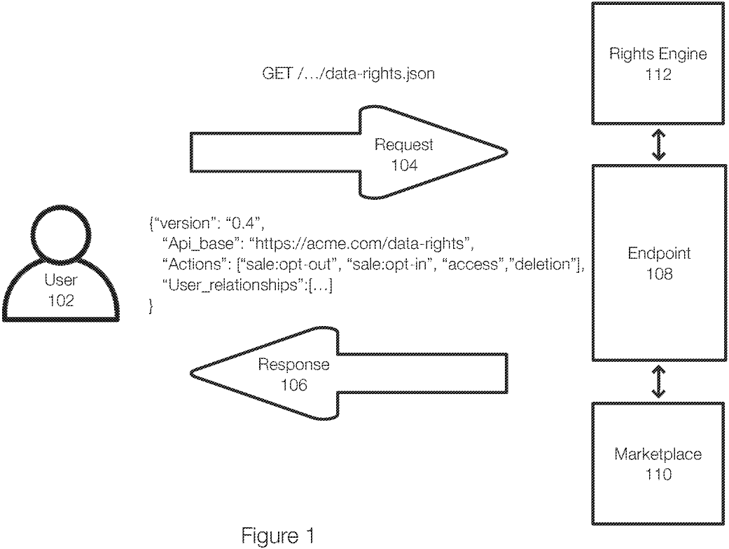

FIG. 1 discloses aspects of data rights operations. Although FIG. 1 illustrates aspects of data rights operations in the context of a user and a user request, data operations may also be performed without user interaction or input.

FIG. 1 illustrates a user 102 that may interact with an endpoint 108. The user 102 may use a device (e.g., computer, phone, tablet) to communicate with the endpoint 108, which may be associated with an entity such as a business. The communication between the user 102 (the user’s device) and the endpoint 108 may occur over the Internet using, for example, a browser.

The user 102 may issue a request 104 via their device. An example of the request 104, GET data rights, is to query the endpoint 108 regarding data rights supported by the entity. The response 106 from the endpoint 108 may include a description of the supported rights, such as “opting out” of the sale of the user’s data, “opting in” to the sale of the user’s data, “accessing” the user’s data, and “deleting” the user’s data.

These rights may be stored in a rights engine 112, which may include a rights database. The rights engine may associate each user with specific data rights and/or with specific users. The rights engine 112 may specify rights to specific data. This allows different rights to be asserted for different data in different ways (e.g., individually, as a group, data specific), even when these data belong to the same user. Any request made by the user 102 regarding the user’s rights may be stored in or by the rights engine 112. The rights engine 112 may include a historian that allows requests and other data rights metadata, operations, sales, or the like to be audited. Whenever the endpoint 108 accesses or uses data of the user 102, the rights engine 112 may operate on the user’s data in accordance with the asserted or set rights or interact with the data management of the endpoint 108 to ensure that the data rights are respected. This may determine whether the use associated with the request is permitted or not permitted. For example, depending on the rights associated with the data of the user 102, the endpoint 108 may be able to offer the user’s data for sale in a marketplace 110 at a price set by the user 102.

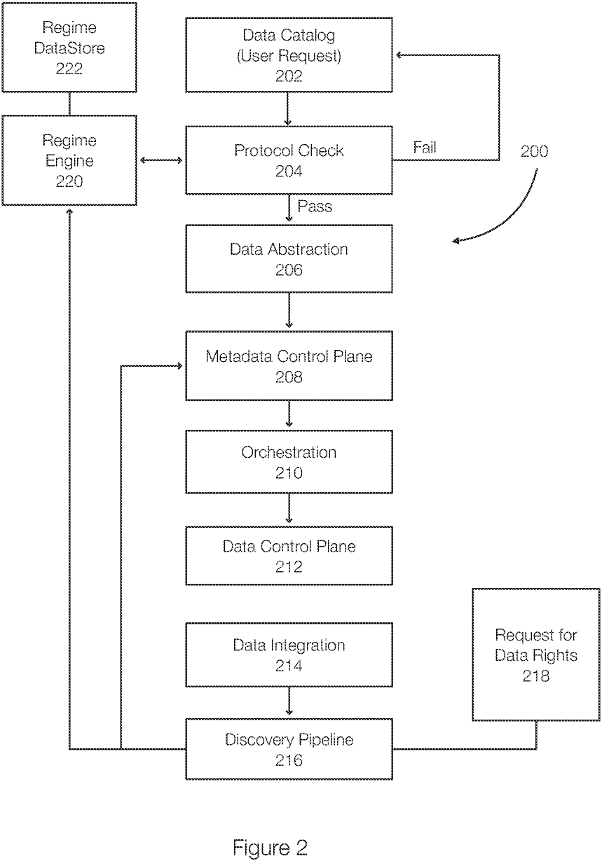

FIG. 2 discloses an example of a rights architecture implemented as a component of or integrated into system 200 such as a scalable infrastructure, a data management system, and/or a marketplace. The rights architecture includes, by way of example, a rights engine. The rights engine may include a regime engine 220, a protocol check 204, and a discovery pipeline 216.

The rights engine may operate within the context of a data management system (e.g., the data catalog, data abstraction, metadata control, orchestration, data control, data integration) to ensure that the rights asserted by users or associated with the users themselves or their data are enforced. For example, a data catalog request (a user request, an employee request, a business request) 202 for user data may be generated or received within the data management system 200. The request 202 may also be associated with a specific use, have a type, or the like. The request 202 may be subject to a protocol check 204. The protocol check 204 may query or access the regime engine 220 to determine whether data rights have been established for the requested data. The regime engine 220 may access a regime datastore 222 to identify any asserted rights.

The protocol check 204, in one example, may either pass, fail, pass with warning, or the like. If the request is incompatible with the rights associated with the data (e.g., the request relates to a sale of the data and the user has opted out of data sales), the request may fail the protocol check 204 and the system may wait for another request. In other words, the request is denied, and the requestor may be notified that the request has been denied. A request can take various forms and may depend on the data being requested and the location of the requested data. For example, the request may relate to accessing a hard drive, a database, cloud data, or other data source and may relate to the sale of the data, deletion of the data, use of the data, or the like.

If the protocol check 204 passes, the request is handled by the data abstraction 206 and the requested data may be accessed in a normal manner. The data abstraction 206 and the metadata control plane 208 may be used to determine where the data is stored for example.

Next, the data access is orchestrated 210 to access the data. This may include issuing a command to the data store to retrieve the data, package the data, or the like. The data control plane 212 may enforce other controls, such as whether the requesting user has the necessary permissions (e.g., an Access Control List) to access the requested data. This type of permission control performed in the data control plane 212 is distinct from the data rights asserted by the user.

The architecture 200 may also include data integration 214 and a discovery pipeline 216. Conventionally, data integration 214 has no ability to ingest data rights. In this example, the discovery pipeline 216 may be included in or be part of data integration 214. The discovery pipeline 216 may be configured to recognize, access, or retrieve data rights and ingest the data rights along with the data. The discovery pipeline may make a request for data rights 218. The request for data rights 218 may include asking the user to specify data rights. The request for data rights 218 may include the user associating the data rights via a separate command or channel that the discovery pipeline 216 can accommodate. The data rights may be appended to the requested data and the discovery pipeline 216 may recognize the presence of the data rights. The discovery pipeline 216 may apply default rights to the data.

The discovery pipeline 216 operates with the data integration 214, which is responsible for taking a data set and adding the data set to the system catalog, to add user data rights to the data being ingested. The discovery pipeline 216 may store the rights in the regime engine 220. If the data being ingested is not associated with or does not include any data rights, the discovery pipeline 216 may add or associate default user rights that may be entity dependent.

In addition, the discovery pipeline 216 may also coordinate with the metadata control plane 208 to integrate any new metadata about user data rights that arrive with the data being ingested.

The regime engine 220 may include or have access to a regime datastore 222. The datastore 222 may include the following structures by way of example:
Table: Regimes [RegimelD, RegimeShortname, RegimeDescriptoin, RegimeGeo, RegimeLink, RegimeRightsArray (rightsID_FK:Values)
Table: Rights [RightsID_PK, ValuesArray(Value:Details), RegimeArray[RegimelD_FK]]
Table: Users [UserID_PK, OrgID_FK(array),
Table: DataRights [DataPK, UserID_FK, RulesArray(RegimelD_FK:Rights_FK:Value), exerciseHistoryArray(userlD, location, command), DataType_FK(optional)]
Table: DataTypes [DataTypePK, DataTypeDescription]
Table: DefaultRights[RightID_PK,OrgID_FK(optional), UserID_FK(optional),RightsArray(rightsID_FK),DataType_FK(optional)

The regime datastore 222 provides this structure, which allows user rights to be stored. The regime datastore 222 stores data rights when data is ingested and may be consulted when data is requested.

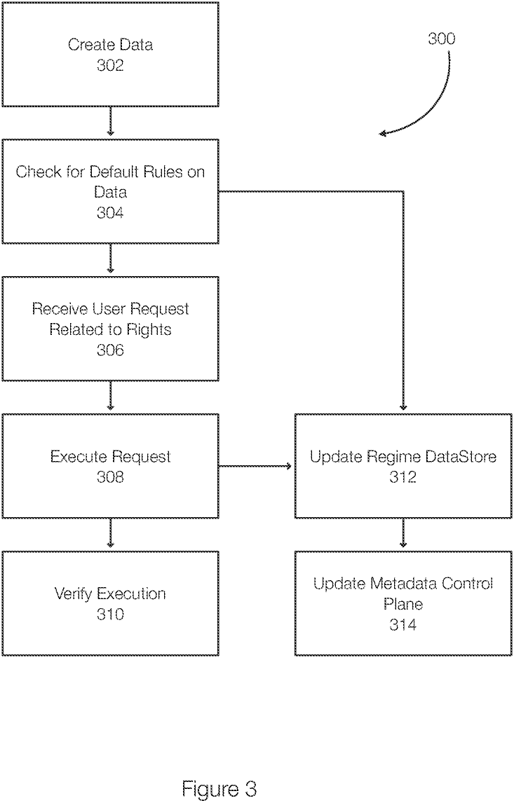

FIG. 3 discloses aspects of enabling, setting, and/or monetizing data rights. The method 300, more specifically, relates to setting a data right (or a data right value) in the regime datastore. The method 300 may be performed in independent pieces and also illustrates aspects of data ingestion using data rights and data rights operations.

In this example, data is created 302. The data may be created by a user or may be imported from a source. When the data is ingested or received, default rules (e.g., sale allowed) for the data are checked 304. Stated differently, a rights engine may check to see if the data is associated with or includes data rights. If the data is not associated with data rights, default data rights may be assigned to the data and stored. Alternatively, the user may already be associated with their own default data rights that can be applied to the data. In one example, checking for default rules 304 includes querying the regime datastore 312 to determine any default rights, rules, or values to be associated with the data. The data or the data rights are then stored in the regime datastore 312. Thus, the data rights, which may include the data, rules, settings, and/or data rights values are registered in the regime datastore 312 and/or in the metadata control plane. Thus, creating 302 data and checking 304 for default rules may represent data ingestion, which may be performed in an ongoing manner and independently of other portions of the method 300.

In one example, the method 300 may begin when a request is received 306 related to user rights. The request may specify specific values for specific data rights for specific data or for the user’s data in general. For example, a request to opt-in to data sale may be provided. The request may specify a price. The request may also specify the context in which the data may be sold. For example, the context or relationship may be sales of the user’s data for marketing purposes, research purposes, or the like or combination thereof. In one example, the request may also specify the relevant regime or the relevant laws or regulations or versions thereof. The request to set or assert certain rights may be conveyed as follows for the GDPR regime:
regime ″: ″GDPR″,
“exercise”: [“sale:opt-in”
“sales-price:$0.50”
″relationships″:[:″customer″,″marketing″]]

In this example, the request includes a regime field to identify the applicable regime, an exercise field that identifies the rights being exercised and corresponding values of the exercised rights, and a relationships field.

This request is executed 308 by the rights engine. This may include incorporating the request (e.g., the data rights or their values) into the regime datastore 312. In other words, the regime datastore 312 is updated in accordance with the user’s request. The execution of the request may be verified 310. For example, a user may send a subsequent request for a report on data right settings or values stored in the regime datastore.

The rights architecture allows a user to request a full set of rules or values, issue a request to update these rules or values, or the like, in the regime datastore.

Once the regime engine including a regime datastore is established, all access requests, display requests, data set pull requests, or generation requests can be intercepted to check the data rights on each piece of data. The rights architecture allows data ingestion and data requests to be performed in the context of user rights. In addition, the personal data rights are scalable and can be applied to each piece of data.

Example rights include, but are not limited to, the right to opt out of sale, the ability to opt in/reconsent to data sale, the right to delete, the right to know, the right to be forgotten, or the like. Data rights can also include access values such as categories and/or specific specifications. An example of categories may include access is granted to populate a form used in the ordinary course of business or for marketing purposes. An example of a specific access may be for a specific marketer.

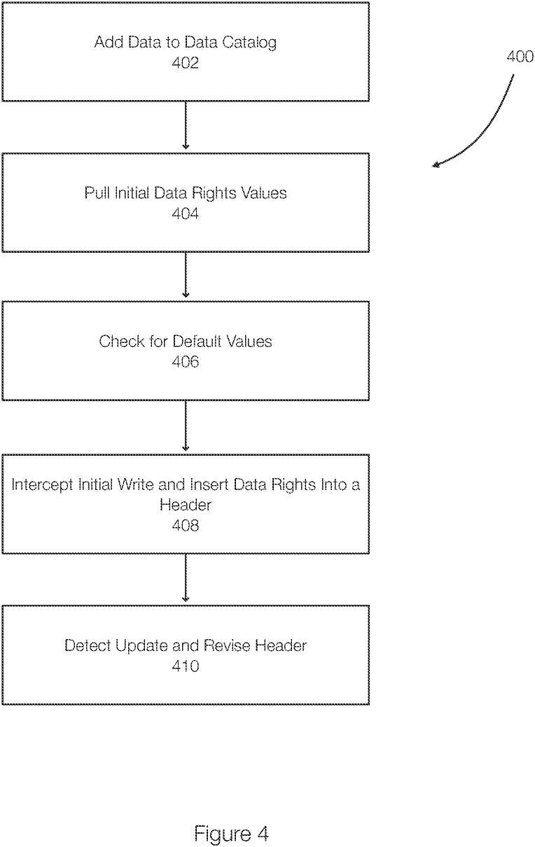

In some embodiments, when data, such as a file, is added to a system, the data may be altered. FIG. 4 discloses aspects of adding or ingesting data into a system. In the method 400, data is added to a catalog (e.g., a computing system, a database, a website) using a data pipeline. The data pipeline may pull 404 initial data rights values from an existing host or location, query the user, or the like. In addition, the data pipeline may check 406 the regime datastore for default values to add to the data being ingested.

When the data is written to a storage device of the system or to other location, the write is intercepted or detected and the data rights that have been determined (e.g., by pulling, by query, by default) are added, in one embodiment, into the regime datastore and/or into a header of the data. If an update to the data rights is detected 410, the regime datastore and/or file header is updated. Thus, as data is added to a system, the data rights operations ensure that, at some stage, that data rights are attached or associated with the data.

In one example, the regime datastore is used to store the data rights, which are associated with users, data, or the like. When the data rights are added to the data in this manner, data can be sold and used without losing the data rights settings. The rights may accompany the data in one example. This also eliminates the ability to deny knowledge regarding the data rights.

Embodiments of the invention capture personal data rights information in a regime datastore, intercept data access requests and enforce data rights, share and sell data in a marketplace or infrastructure, and use a datastore to establish default rules and regulations for use in enforcing data rights.

Up-to-date data rights can be attached directly to data as a header. This allows current data rights to be established as the data is transmitted or the like. The rights architecture further allows users to set prices for the use of individual data records and files and allow a user to query and establish how their data has been used and what the user may be owed using historical access records. Further, embodiments of the invention allow developers and data scientists to proactively validate that the data being used is compliant with personal data rights by simply reading the data’s header.

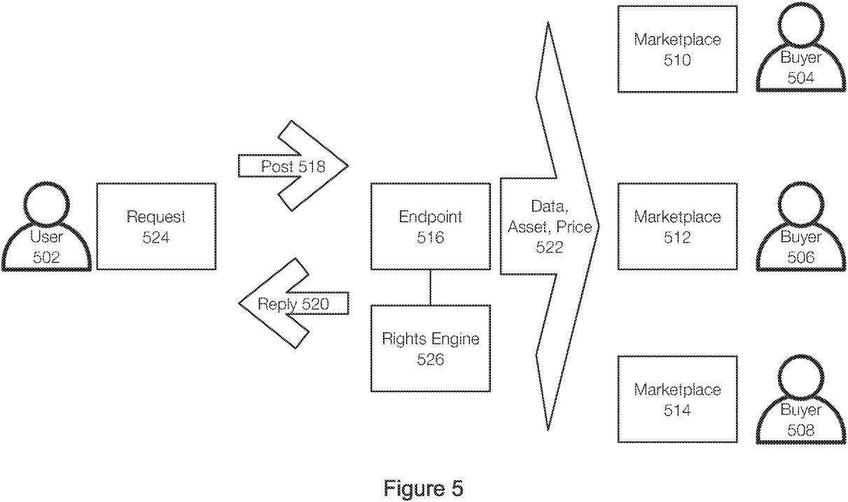

FIG. 5 discloses aspects of exercising data rights. In FIG. 5, a user 502 may post 518 a request to an endpoint 516. The request 524, in this example, may include a request to opt-in to sale of the user’s data and set a price. The request is implemented at the endpoint 516 and stored in a rights engine 526 (e.g., the regime datastore).

A request to sell the data of the user 502 may be generated. This request may be intercepted as previously described and the data rights for the data are determined. If the request is acceptable or permitted by the data rights, the endpoint 516 may post the data for sale. In this example, the data (or asset) and price 522 are added to one or more marketplaces 510, 512, and 514 and may be purchased by one or more of the buyers 504, 506, and 508.

If a sale of the user’s 502 data is completed, the sale may be reflected in the right engine 526. Further, a reply 520 such as a sale callback may be generated to inform the user 502 of the sale. In another example, the user 502 can issue a request or post 518 to inquire regarding whether any sales have been made and to determine any balance owed to the user 502.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data rights operations. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, virtual machines (VM), or containers.

Particularly, devices in the operating environment may take the form of software, physical machines, VMs, containers, or any combination of these, though no particular device implementation or configuration is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: detecting a request for data in a computing system, performing a protocol check on the data to identify user data rights associated with the requested data, wherein the data rights are stored in a regime engine, orchestrating the request for the data in accordance with the data rights, and enforcing the data rights when performing the request.

Embodiment 2. The method of embodiment 1, further comprising ingesting the data into the computing system.

Embodiment 3. The method of embodiment 1 and/or 2, further comprising requesting data rights associated with the data when the data is ingested.

Embodiment 4. The method of embodiment 1, 2, and/or 3, further comprising associating default data rights with the data.

Embodiment 5. The method of embodiment 1, 2, 3, and/or 4, wherein the request includes opting in to selling the data and includes a price.

Embodiment 6. The method of embodiment 1, 2, 3, 4, and/or 5, further comprising updating the regime engine with the data rights identified in the request.

Embodiment 7. The method of embodiment 1, 2, 3, 4, 5, and/or 6, further comprising selling the data in an online marketplace.

Embodiment 8. The method of embodiment 1, 2, 3, 4, 5, 6, and/or 7, further comprising replying to the request with a reply, wherein the reply includes details of any sale of the data.

Embodiment 9. The method of embodiment 1, 2, 3, 4, 5, 6, 7, and/or 8, further comprising receiving a second request, wherein the second request is to determine if the request was completed in the regime engine.

Embodiment 10. The method of embodiment 1, 2, 3, 4, 5, 6, 7, 8, and/or 9, wherein the request specifies a regime field that identifies a regime, an exercise field that identifies rights being exercised and corresponding values, and a relationships field.

Embodiment 11. The method as recited in any of embodiments 1-10, wherein the method is performed by a computing device, server, or system.

Embodiment 12. A method for performing any of the operations, methods, or processes, or any portion of any of these or any combination thereof, disclosed herein.

Embodiment 14. A non-transitory storage medium having stored therein instructions that are executable by one or more hardware processors to perform operations comprising the operations of any one or more of embodiments 1-13.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

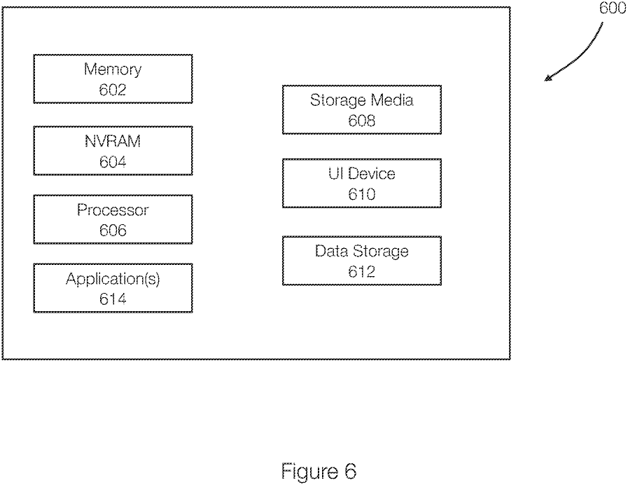

With reference briefly now to FIG. 6, any one or more of the entities disclosed, or implied, by the Figures and/or elsewhere herein, may take the form of, or include, or be implemented on, or hosted by, a physical computing device, a computing system or network, one example of which is denoted at 600. As well, where any of the aforementioned elements comprise or consist of a virtual machine (VM) or container, that may constitute a virtualization of any combination of the physical components disclosed in FIG. 6.

In the example of FIG. 6, the physical computing device 600 includes a memory 602 which may include one, some, or all, of random-access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid-state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
detecting a request for data in a computing system;
performing a protocol check on the data to identify user data rights associated with the requested data, wherein the data rights are stored in a regime engine;
orchestrating the request for the data in accordance with the data rights; and
enforcing the data rights when performing the request.

2. The method of claim 1, further comprising ingesting the data into the computing system.

3. The method of claim 2, further comprising requesting data rights associated with the data when the data is ingested.

4. The method of claim 3, further comprising associating default data rights with the data.

5. The method of claim 1, wherein the request includes opting in to selling the data and includes a price.

6. The method of claim 5, further comprising updating the regime engine with the data rights identified in the request.

7. The method of claim 6, further comprising selling the data in an online marketplace.

8. The method of claim 7, further comprising replying to the request with a reply, wherein the reply includes details of any sale of the data.

9. The method of claim 8, further comprising receiving a second request, wherein the second request is to determine if the request was completed in the regime engine.

10. The method of claim 1, wherein the request specifies a regime field that identifies a regime, an exercise field that identifies rights being exercised and corresponding values, and a relationships field.

11. A non-transitory storage medium having stored therein instructions that are executable by one or more hardware processors to perform operations comprising:
detecting a request for data in a computing system;
performing a protocol check on the data to identify user data rights associated with the requested data, wherein the data rights are stored in a regime engine;
orchestrating the request for the data in accordance with the data rights; and
enforcing the data rights when performing the request.

12. The non-transitory storage medium of claim 11, further comprising ingesting the data into the computing system.

13. The non-transitory storage medium of claim 12, further comprising requesting data rights associated with the data when the data is ingested.

14. The non-transitory storage medium of claim 13, further comprising associating default data rights with the data.

15. The non-transitory storage medium of claim 11, wherein the request includes opting in to selling the data and includes a price.

16. The non-transitory storage medium of claim 15, further comprising updating the regime engine with the data rights identified in the request.

17. The non-transitory storage medium of claim 16, further comprising selling the data in an online marketplace.

18. The non-transitory storage medium of claim 17, further comprising replying to the request with a reply, wherein the reply includes details of any sale of the data.

19. The non-transitory storage medium of claim 18, further comprising receiving a second request, wherein the second request is to determine if the request was completed in the regime engine.

20. The non-transitory storage medium of claim 11, wherein the request specifies a regime field that identifies a regime, an exercise field that identifies rights being exercised and corresponding values, and a relationships field.
